(19) United States
(12) Patent Application Publication
(10) Pub. No.: US 2014/0285599 A1
(43) Pub. Date: Sep. 25, 2014

(54) REDUCTION OF INK TEMPERATURES IN A RADIANT DRYER

(71) Applicants: Stuart J. Boland, Denver, CO (US); Sean K. Fitzsimons, Thornton, CO (US); Scott Johnson, Erie, CO (US); William Edward Manchester, Erie, CO (US); Casey E. Walker, Boulder, CO (US)

(72) Inventors: Stuart J. Boland, Denver, CO (US); Sean K. Fitzsimons, Thornton, CO (US); Scott Johnson, Erie, CO (US); William Edward Manchester, Erie, CO (US); Casey E. Walker, Boulder, CO (US)

(21) Appl. No.: 13/850,045

(22) Filed: Mar. 25, 2013

(51) Int. Cl. B41J 11/00

(52) U.S. Cl. CPC B41J 11/002
USPC 347/102

(57) ABSTRACT

Systems and methods for reducing ink temperatures in a radiant dryer. In one embodiment, a fluid dispersion unit is implemented in a printing system. The printing system includes a production printer that is operable to apply ink on a front side of a continuous-form medium, and includes a radiant dryer that is operable to dry the ink that is applied on the front side of the medium. The liquid dispersion unit is configured to apply a liquid on a back side of the medium before the medium enters the radiant dryer.

### FIELD OF THE INVENTION

The invention relates to the field of production printing and, in particular, to radiant drying of ink applied to a medium.

### BACKGROUND

Businesses or other entities having a need for volume printing typically purchase a production printer. A production printer is a high-speed printer used for volume printing, such as 100 pages per minute or more. The production printers are typically continuous-form printers that print on paper or some other printable medium that is stored on large rolls.

A production printer typically includes a localized print controller that controls the overall operation of the printing system, and a print engine (sometimes referred to as an “imaging engine” or as a “marking engine”). The print engine includes one or more printhead assemblies, with each assembly including a printhead controller and a printhead (or array of printheads). An individual printhead includes multiple tiny nozzles (e.g., 360 nozzles per printhead depending on resolution) that are operable to discharge ink as controlled by the printhead controller. The printhead array is formed from multiple printheads that are spaced in series along a particular width so that printing may occur across the width of the medium.

When in operation, the printable medium is passed underneath the printhead arrays of the print engine while the nozzles of the printheads discharge ink at particular intervals to form pixels on the medium. Some of the media used in inkjet printers is better suited to absorb the ink, while others are not. Thus, a radiant dryer may be installed downstream from the print engine. The radiant dryer assists in drying the ink on the medium after the medium leaves the print engine. A typical radiant dryer includes an array of lamps that emit light and heat. The light and heat from the lamps help to dry the ink as the medium passes through the dryer.

Some production printers are able to print multiple colors, such as CMYK. CMYK is a color model that uses four colors of ink: Cyan, Magenta, Yellow, and Key (black). Darker-color ink, such as Key (K) black, can cause problems when radiant dryers are installed downstream from a printhead array. The darker-color ink absorbs more radiant energy per volume from the dryer, so it dries faster than lighter colors. If the darker ink dries too fast, it can cause discoloration on the opposite side of the medium or begin to burn or scorch on the medium.

### SUMMARY

Embodiments described herein apply a liquid on the back side of the medium before the medium reaches the radiant dryer. The liquid on the back side of the medium absorbs some of the radiant energy from the radiant dryer so that ink applied to the front side of the medium does not reach as high a temperature within the radiant dryer. Therefore, the medium is less likely to discolor or scorch in the radiant dryer due to inks reaching too high of temperatures. Also, the liquid hydrates the medium so that the paper does not shrink after exiting the radiant dryer.

One embodiment comprises a liquid dispersion unit implemented in a printing system. The printing system includes a production printer that is operable to print ink on a front side of a continuous-form medium, and includes a radiant dryer that is operable to dry the ink that is applied on the front side of the medium by the production printer. The liquid dispersion unit is configured to apply a liquid on a back side of the medium before the medium enters the radiant dryer.

In another embodiment, the printing system includes a second production printer that is operable to print ink on the back side of the medium, and includes a second radiant dryer that is operable to dry the ink that is applied on the back side of the medium by the second production printer. The liquid dispersion unit is configured to apply the liquid on the front side of the medium before the medium enters the second radiant dryer.

In another embodiment, the liquid dispersion unit includes at least one spray nozzle configured to evenly spray a mist of liquid across a width of the back side of the medium, a controller configured to control a flow rate of the liquid through the spray nozzles, and a reservoir configured to store the liquid.

In another embodiment, the liquid dispersion unit is configured to adjust the amount of liquid applied on the back side of the medium based on the speed of the medium.

In another embodiment, the liquid dispersion unit is configured to adjust the amount of liquid applied on the back side of the medium based on a power level being used within the radiant dryer.

In another embodiment, the liquid comprises water or a solution of water and alcohol.

Another embodiment comprises a method operable in a printing system. The method includes applying ink on a front side of a continuous-form medium, applying a liquid on a back side of the medium, and drying the ink on the front side of the medium in a radiant dryer.

Another embodiment is an apparatus comprising a production printer configured to receive a continuous-form medium, and apply ink on a front side of the medium. The apparatus further includes a liquid dispersion unit configured to apply a liquid on a back side of the medium after the ink is applied on the front side of the medium by the production printer. The apparatus further includes a radiant dryer configured to receive the medium after the liquid is applied on the back side of the medium, and to dry the ink that is applied on the front side of the medium.

The invention may include other exemplary embodiments described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a printing system.

FIG. 2 is a graph illustrating the drying temperatures of different color inks

FIG. 3 is a schematic diagram of a production printer in an exemplary embodiment.

FIG. 4 illustrates a liquid dispersion unit in an exemplary embodiment.

FIG. 5 is a flow chart illustrating a method of reducing ink temperatures in a radiant dryer in an exemplary embodiment.

FIG. 6 illustrates a printing system including a second production printer and a second radiant dryer in an exemplary embodiment.

FIG. 7 illustrates a computing system in an exemplary embodiment.

### DETAILED DESCRIPTION

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

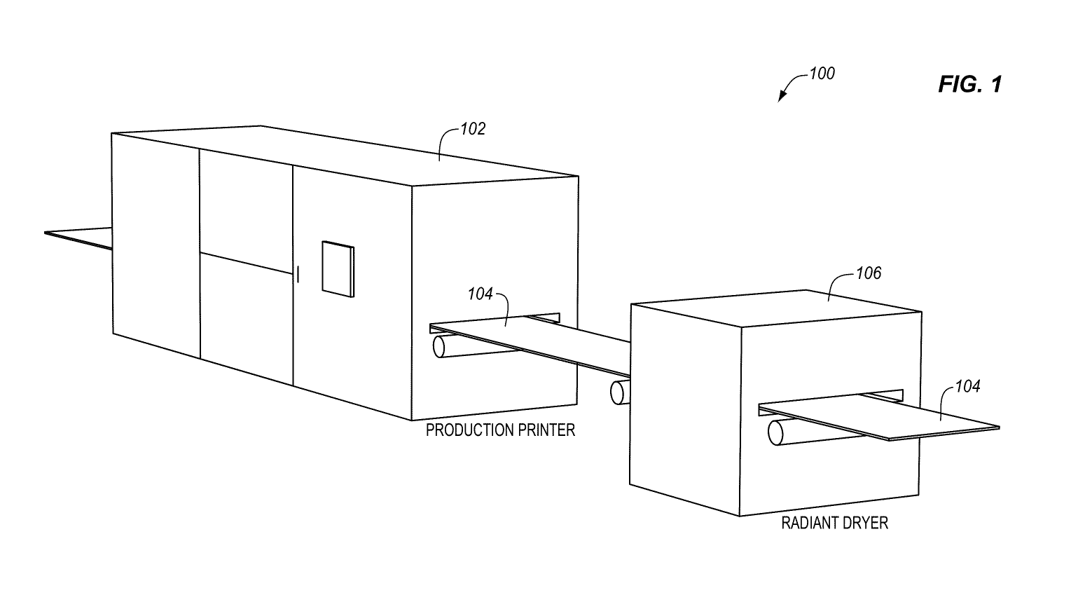

FIG. 1 illustrates a printing system 100. Printing system 100 includes a production printer 102 that is operable to print onto a continuous-form medium 104. A production printer is a high-speed printer that is used for volume printing. The printing speed of production printers can reach 200 linear feet per minute or more. Printer 102 may comprise a monochrome printer, or a color printer able to apply color ink, such as Cyan (C), Magenta (M), Yellow (Y), and Key (K) black.

Printing system 100 also includes a radiant dryer 106. Radiant dryer 106 is a unit or module installed in printer 102 or downstream from printer 102 (as shown in FIG. 1). After printer 102 applies ink to medium 104, the ink applied to medium 104 is wet. Thus, medium 104 travels through radiant dryer 106 where an array of light bulbs (not shown) radiate infrared energy including the near-infrared region to dry the ink on medium 104.

A problem may occur when medium 104 travels through radiant dryer 106. Different color inks absorb more radiant energy than the other color inks For example, “K black” ink and other dark colors absorb more radiant energy than lighter colors. Because the darker colors absorb more radiant energy, the ink will reach a higher temperature than the other color inks in radiant dryer 106 and will dry at a faster rate. The temperature an ink reaches while drying in radiant dryer 106 is referred to herein as a “drying temperature”.

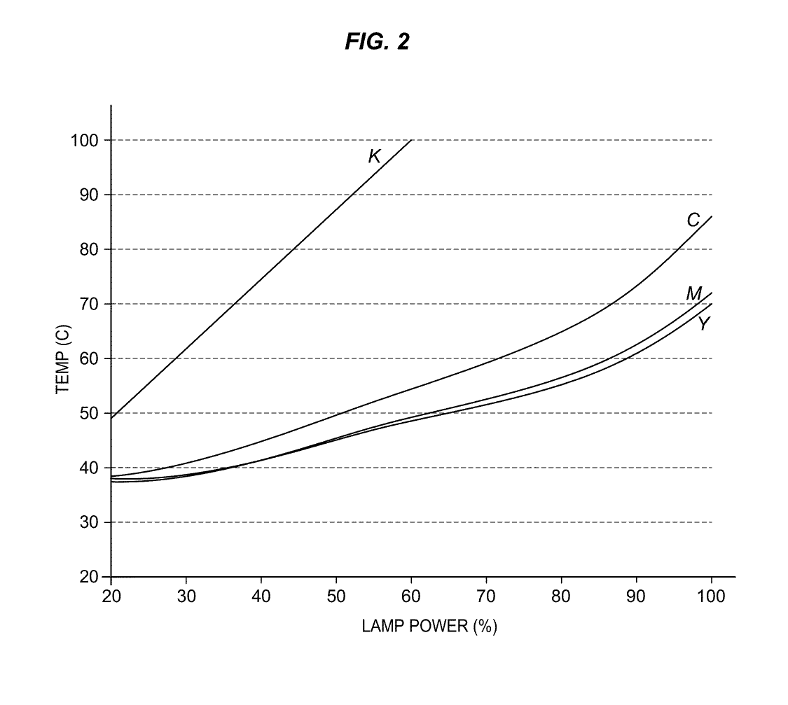

FIG. 2 is a graph illustrating the drying temperatures of different color inks The graph illustrates the drying temperatures of C, M, Y, and K black as a function of lamp power downstream from radiant dryer 106. For this graph, the temperatures would be measured some distance downstream of dryer 106, so the ink temperature can be much higher during the drying process. As the lamp power increases, the graph shows that the drying temperatures of C, M, and Y ink tend to increase gradually by the same amount. For example, at 50% lamp power, the drying temperatures of C, M, and Y ink are each about 50 degrees Celsius. The drying temperatures of K black ink are much higher than the other ink colors. As the lamp power increases, the drying temperature of K black ink increases a greater amount than the other color inks For example, at 50% lamp power, the drying temperature of K black ink is about 85 degrees Celsius. Thus, the K black ink will dry at much higher temperatures than the other ink colors in radiant dryer 106, and will dry at a faster rate.

When darker-color ink reaches higher drying temperatures within radiant dryer 106, there is a risk that the opposite side of medium 104 will become discolored or that darker-color inks will burn or scorch on medium 104. To prevent this situation, printing system 100 is enhanced in the following embodiments to lower the drying temperature of ink in radiant dryer 106. As an overview, a liquid (e.g., water) is applied to the back side of medium 104 before the medium 104 advances into radiant dryer 106. The liquid reduces the overall temperature of medium 104, and provides a more efficient heat transfer surface for conduction. Therefore, the darker-color inks will not reach as high of temperatures within radiant dryer 106.

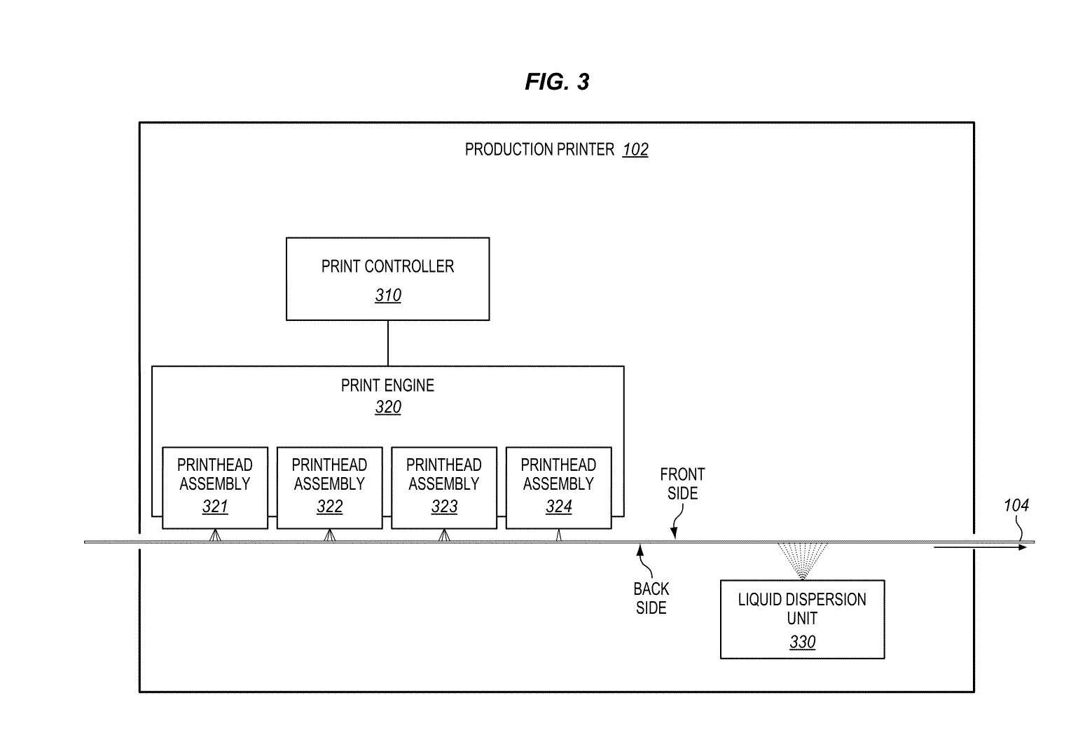

FIG. 3 is a schematic diagram of production printer 102 in an exemplary embodiment. Production printer 102 includes a print controller 310 and a print engine 320. Print controller 310 comprises a processing unit that receives a print job from a host system, such as in a Page Description Language (PDL), and translates the print job into a raster image that print engine 320 is able to print. The raster image may also be referred to as a bitmap. Print engine 320 includes a plurality of printhead assemblies 321-324. Each printhead assembly 321-324 includes an ink reservoir, a printhead controller, and one or more printheads (not shown). The printhead controllers receive a bitmap from print controller 310, and control the nozzles of their associated printhead to spray ink in the pixel locations indicated in the bitmap.

Production printer 102 in this embodiment also includes a liquid dispersion unit 330. Liquid dispersion unit 330 is a module installed in printer 102 (as shown in FIG. 3) or outside of printer 102 between print engine 320 and radiant dryer 106 (see FIG. 1). After ink is applied on one side of medium 104 (such as by print engine 320), liquid dispersion unit 330 is operable to apply a liquid on the opposing side of medium 104. Liquid dispersion unit 330 therefore applies the liquid on the non-printed side of medium 104 before medium 104 advances to radiant dryer 106. The liquid is a non-marking solution that adds moisture to medium 104. In other words, the liquid is not an ink or similar solution that includes pigments or dyes that actually mark the medium 104. For example, the liquid may comprise water, a solution of water and alcohol, or some other aqueous or water-based solution that is non-marking.

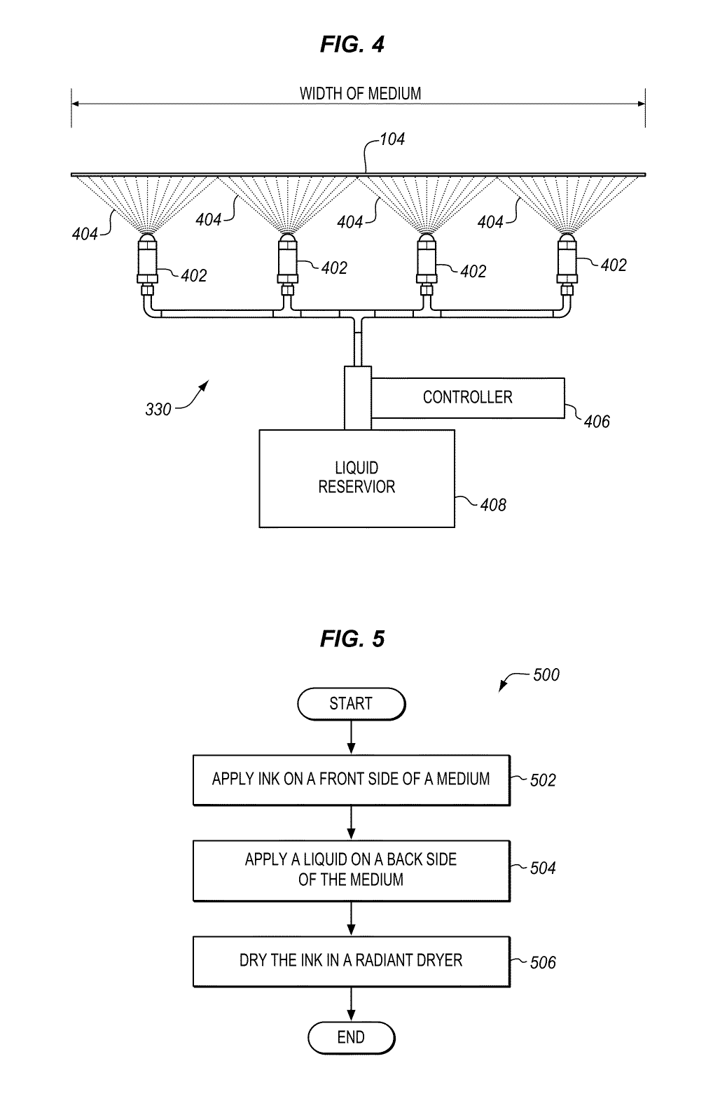

FIG. 4 illustrates liquid dispersion unit 330 in an exemplary embodiment. In this embodiment, liquid dispersion unit 330 includes a plurality of spray nozzles 402 that are able to spray a mist 404 of liquid on the back side of medium 104. Nozzles 402 are spaced along the width of medium 104 to evenly spray the mist 404 of liquid across the width of medium 104. Liquid dispersion unit 330 further includes a controller 406 and a liquid reservoir 408. Controller 406 comprises any component that is able to control the application of the liquid by nozzles 402 on the back side of medium 104. Controller 406 is able to actuate nozzles 402 (i.e., on/off), and is also able to control the flow rate of nozzles 402. Reservoir 408 comprises any container that is able to store the liquid.

FIG. 5 is a flow chart illustrating a method 500 of reducing ink temperatures in radiant dryer 106 in an exemplary embodiment. The steps of method 500 will be described with reference to printing system 100 in FIG. 1, although the methods described herein may be performed in other systems. The steps of the flow chart described herein are not all inclusive and may include other steps not shown.

When in operation, production printer 102 receives medium 104 that is advancing from left to right in FIG. 3. As medium 104 passes underneath printhead assemblies 321-324, print engine 320 applies ink on the front side of the medium 104 in step 502. After ink is applied on medium 104 by print engine 320, medium continues to advance toward liquid dispersion unit 330. Liquid dispersion unit 330 then applies a liquid on the back side of medium 104 in step 504. Medium 104 then continues to advance toward radiant dryer 106 (see FIG. 1). As medium 104 passes through radiant dryer 106, radiant dryer 106 dries the ink on the front side of medium 104 in step 506. The liquid applied to the back side of medium 104 absorbs some of the energy in radiant dryer 106 that would normally be absorbed by the ink on the front side of medium 104. More specifically, the areas that are absorbing more energy will be able to dissipate more heat into the liquid than other areas allowing for a reduction in temperature variation based on printed ink energy absorption. Therefore, the high energy absorbing ink on the front side of medium 104 will not reach as high of a drying temperature within radiant dryer 106, which reduces the risk of discoloration or scorching due to inks reaching too high of a temperature. Also, the liquid acts to hydrate medium 104 so that the overall moisture content of medium 104 after the drying process is close to the original moisture content of medium 104. This reduces shrinkage of medium 104 due to the drying process.

Liquid dispersion unit 330 may vary the amount of liquid that is applied on the back side of medium 104. In one embodiment, liquid dispersion unit 330 may adjust the amount of liquid applied on the back side of medium 104 based on the speed of medium 104. For example, when medium 104 is travelling at higher speeds, then liquid dispersion unit 330 may apply the liquid at higher flow rates than when medium 104 is travelling at lower speeds. In another embodiment, liquid dispersion unit 330 may adjust the amount of liquid applied on the back side of medium 104 based on a power level being used within radiant dryer 106. For example, if the power levels are lower in radiant dryer 106, then liquid dispersion unit 330 may determine that little or no liquid needs to be applied. However, if the power levels are higher in radiant dryer 106, then liquid dispersion unit 330 may determine that more liquid needs to be applied.

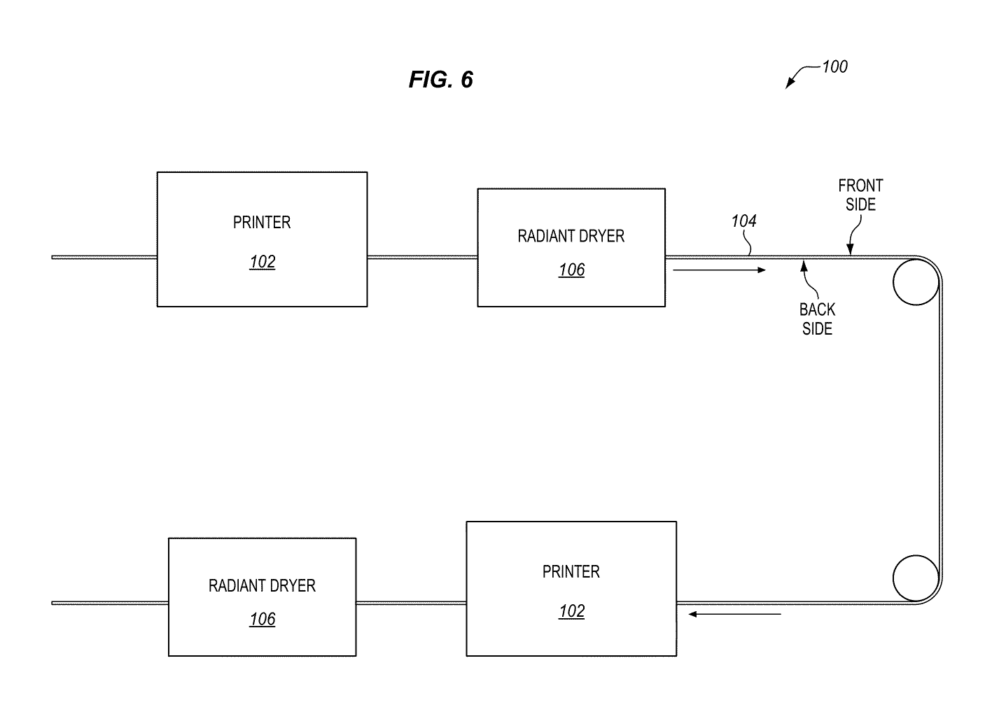

Printing system 100 may be configured for two sided printing. Therefore, printing system 100 may include a second production printer (for back side printing) and a second radiant dryer that are downstream from production printer 102 and radiant dryer 106. FIG. 6 illustrates printing system 100 including a second production printer 602 and a second radiant dryer 606 in an exemplary embodiment. After printer 102 prints on the front side of medium 104 and the ink is dried in radiant dryer 106, medium 104 travels to production printer 602. Those skilled in the art understand that there may be a turning apparatus installed upstream from printer 602 that turns medium 104 so that the back side of medium 104 faces upward before entering printer 602. Those skilled in the art also understand that ink printed on the front side of medium 104 is dried at this point.

Production printer 602 receives medium 104 that is advancing from right to left in FIG. 6. As medium 104 passes through printer 602, printer 602 applies ink on the back side of the medium 104. After ink is applied on medium 104 by printer 602, liquid dispersion unit 330, which is installed in printer 602 in a similar manner as shown in FIG. 3, applies a liquid on the front side of medium 104. When the liquid is being applied to the front side that has previously been printed on and then dried, the liquid is a compound that does not distort the already dried image on the front side of medium 104. Thus, the liquid does not cause print quality degradation of the images printed on the front side. Medium 104 then continues to advance toward radiant dryer 606. As medium 104 passes through radiant dryer 606, radiant dryer 606 dries the ink on the back side of medium 104. The liquid applied to the front side of medium 104 absorbs some of the energy in radiant dryer 606 that would normally be absorbed by the ink on the front side of medium 104. Therefore, the high energy absorbing ink on the back side of medium 104 will not reach as high of a drying temperature within radiant dryer 606, which reduces the risk of discoloration or scorching due to inks reaching too high of a temperature.

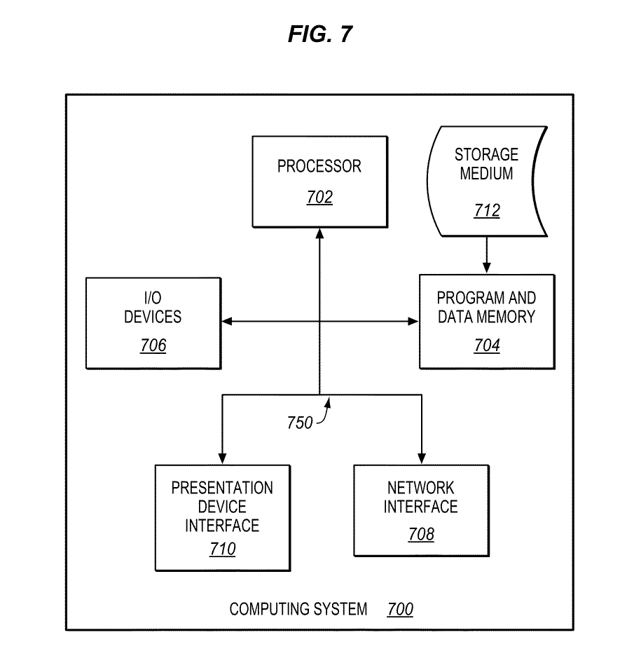

The controllers described herein can take the form of an entirely hardware embodiment, an entirely software embodiment or an embodiment containing both hardware and software elements. In one embodiment, the controllers may be implemented in software, which includes but is not limited to firmware, resident software, microcode, etc. FIG. 7 illustrates a computing system 700 in an exemplary embodiment.

Furthermore, the invention can take the form of a computer program product accessible from a computer-usable or computer-readable medium 712 providing program code for use by or in connection with a computer or any instruction execution system. For the purposes of this description, a computer-usable or computer readable medium 712 can be any apparatus that can contain, store, communicate, or transport the program for use by or in connection with the instruction execution system, apparatus, or device.

The medium 712 can be an electronic, magnetic, optical, electromagnetic, infrared, or semiconductor system (or apparatus or device) or a propagation medium. Examples of a computer-readable medium 712 include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include one or more processors 702 coupled directly or indirectly to memory 704 through a system bus 750. The memory 704 can include local memory employed during actual execution of the program code, bulk storage, and cache memories which provide temporary storage of at least some program code in order to reduce the number of times code is retrieved from bulk storage during execution.

Input/output or I/O devices 706 (including but not limited to keyboards, displays, pointing devices, etc.) can be coupled to the system either directly or through intervening I/O controllers, as can a presentation device interface (I/F) 710.

Network adapters may also be coupled to the system to enable the data processing system to become coupled to other data processing systems, such a through network interfaces 708, or remote printers or storage devices through intervening private or public networks. Modems, cable modem and Ethernet cards are just a few of the currently available types of network adapters.

Although specific embodiments were described herein, the scope of the invention is not limited to those specific embodiments. The scope of the invention is defined by the following claims and any equivalents thereof

We claim:

1. An apparatus comprising:
a liquid dispersion unit implemented in a printing system, wherein the printing system includes a production printer that is operable to apply ink on a front side of a continuous-form medium, and includes a radiant dryer that is operable to dry the ink that is applied on the front side of the medium by the production printer;
the liquid dispersion unit is configured to apply a liquid on a back side of the medium before the medium enters the radiant dryer.

2. The apparatus of claim 1 wherein:
the printing system includes a second production printer that is operable to print ink on the back side of the medium, and includes a second radiant dryer that is operable to dry the ink that is applied on the back side of the medium by the second production printer; and
the liquid dispersion unit is configured to apply the liquid on the front side of the medium before the medium enters the second radiant dryer.

3. The apparatus of claim 1 wherein:
the liquid dispersion unit includes:
at least one spray nozzle configured to evenly spray a mist of the liquid across a width of the back side of the medium;
a controller configured to control a flow rate of the liquid through the spray nozzles; and
a reservoir configured to store the liquid.

4. The apparatus of claim 1 wherein:
the liquid dispersion unit is configured to adjust the amount of liquid applied on the back side of the medium based on the speed of the medium.

5. The apparatus of claim 1 wherein:
the liquid dispersion unit is configured to adjust the amount of liquid applied on the back side of the medium based on a power level being used within the radiant dryer.

6. The apparatus of claim 1 wherein:
the liquid comprises water.

7. The apparatus of claim 1 wherein:
the liquid comprises a solution of water and alcohol.

8. A method operable in a printing system, the method comprising:
applying ink on a front side of a continuous-forms medium;
applying a liquid on a back side of the medium; and
drying the ink on the front side of the medium in a radiant dryer.

9. The method of claim 8 further comprising:
after the ink on the front side of the medium is dry,
applying ink on the back side of the medium;
applying a liquid on the front side of the medium; and
drying the ink on the back side of the medium in a second radiant dryer.

10. The method of claim 8 further comprising:
actuating at least one spray nozzle to evenly spray a mist of the liquid across a width of the back side of the medium.

11. The method of claim 8 further comprising:
adjusting the amount of liquid applied on the back side of the medium based on the speed of the medium.

12. The method of claim 8 further comprising:
adjusting the amount of liquid applied on the back side of the medium based on a power level being used within the radiant dryer.

13. The method of claim 8 wherein:
the liquid comprises water.

14. The method of claim 8 wherein:
the liquid comprises a solution of water and alcohol.

15. An apparatus comprising:
a production printer configured to receive a continuous-form medium, and to apply ink on a front side of the medium;
a liquid dispersion unit configured to apply a liquid on a back side of the medium after the ink is applied on the front side of the medium; and
a radiant dryer configured to receive the medium after the liquid is applied on the back side of the medium, and to dry the ink that is applied on the front side of the medium.

16. The apparatus of claim 15 wherein:
the liquid dispersion unit is configured to spray a mist of the liquid on the back side of the medium.

17. The apparatus of claim 16 wherein:
the liquid dispersion unit includes:
at least one spray nozzle configured to evenly spray the mist of the liquid across a width of the back side of the medium;
a controller configured to control a flow rate of the liquid through the spray nozzles; and
a reservoir configured to store the liquid.

18. The apparatus of claim 15 wherein:
the liquid dispersion unit is configured to adjust the amount of liquid applied on the back side of the medium based on the speed of the medium.

19. The apparatus of claim 15 wherein:
the liquid dispersion unit is configured to adjust the amount of liquid applied on the back side of the medium based on a power level being used within the radiant dryer.

20. The apparatus of claim 15 wherein:
the liquid comprises water.
